(19) United States
(12) Patent Application Publication
(10) Pub. No.: US 2019/0359449 A1
(43) Pub. Date: Nov. 28, 2019

(54) ENTRYWAY INDICATORS

(71) Applicant: Otis Elevator Company, Farmington, CT (US)

(72) Inventors: Walter Thomas Schmidt, Marlborough, CT (US); Enrico Manes, Feeding Hills, MA (US); Joseph V. Mantese, Ellington, CT (US); Paul R. Braunwart, Hebron, CT (US); Fanping Sun, Glastonbury, CT (US); Goran Djuknic, New York, NY (US); Ziyou Xiong, Wethersfield, CT (US); Norbert Antony Murray Hootsmans, South Glastonbury, CT (US)

(21) Appl. No.: 15/987,635

(22) Filed: May 23, 2018

(51) Int. Cl. B66B 3/00; G08B 7/06

(52) U.S. Cl. CPC B66B 3/002; B66B 3/008; G08B 7/066

(57) ABSTRACT

Disclosed is a people flow management system including: an entryway through which people pass through, an image control apparatus that displays a first plurality of graphical indicia, the first plurality of graphical indicia being directed to controlling a flow of people passing through the entryway and comprising a first indicia indicative of the entryway being accessible for people passing through and a second indicia indicative of the entryway being inaccessible, wherein the image control apparatus displays an indicia from the first plurality of graphical indicia at one or more of a plurality of locations, the plurality of locations including: a first location above the entryway, and a second location on a floor below the entryway.

### BACKGROUND

Exemplary embodiments pertain to the art of entryways and more specifically to entryway indicators.

Abnormal behavior surrounding an entryway such as an elevator doorway may be attributed to a lack of understanding relating to 1) the operation of elevator door detection systems and sensors, 2) the capabilities of elevator object and passenger sensors, and 3) the functioning of elevator door opening and closing algorithms. When a person does not know when a door will close, the person may attempt to cross an elevator threshold late into an elevator closing cycle and a door strike may occur.

### BRIEF DESCRIPTION

Disclosed is a people flow management system comprising: an entryway through which people pass through, an image control apparatus that displays a first plurality of graphical indicia, the first plurality of graphical indicia being directed to controlling a flow of people passing through the entryway and comprising a first indicia indicative of the entryway being accessible for people passing through and a second indicia indicative of the entryway being inaccessible, wherein the image control apparatus displays an indicia from the first plurality of graphical indicia at one or more of a plurality of locations, the plurality of locations including: a first location above the entryway, and a second location on a floor below the entryway.

In addition to one or more of the above disclosed features, or as an alternative, the first indicia graphically indicates the entryway is accessible for passing through, and the second indicia graphically indicates the entryway is inaccessible, and wherein the first plurality of graphical indicia includes a third indicia that graphically indicates the entryway is imminently inaccessible.

In addition to one or more of the above disclosed features, or as an alternative, the first indicia graphically identifies that an accessible travel path for approaching the entryway is through a center of an entryway threshold.

In addition to one or more of the above disclosed features, or as an alternative, the first indicia includes a first shape, and the second indicia includes a second shape, the second shape being different than the first shape.

In addition to one or more of the above disclosed features, or as an alternative, the first shape is a first color, and the second shape is a second color, the second color being different than the first color.

In addition to one or more of the above disclosed features, or as an alternative, the first indicia includes first text overlying the first shape, and the second indicia includes second text overlying the second shape, wherein the second text differs from the first text.

In addition to one or more of the above disclosed features, or as an alternative, the image control feature comprises: a luminous source for variously displaying the first plurality of graphical indicia, a first controller for controlling when the illuminous source displays the first plurality of graphical indicia.

In addition to one or more of the above disclosed features, or as an alternative, the luminous source is electronic display including an active panel display or a projecting display, wherein the electronic display is supported above the entryway or on the floor.

In addition to one or more of the above disclosed features, or as an alternative, the first controller receives from a second controller a second plurality of graphical indicia directed to marketing for displaying with the illuminous source.

In addition to one or more of the above disclosed features, or as an alternative, the first controller controls the illuminous source to contemporaneously display the plurality of graphical indicia.

Further disclosed is a method of controlling a flow or people through an entryway, the method including: displaying a first plurality of graphical indicia, the first plurality of graphical indicia being directed to controlling a flow of people passing through the entryway and comprising a first indicia indicative of the entryway being accessible for people passing through and a second indicia indicative of the entryway being inaccessible, wherein the first plurality of graphical indicia is displayed at one or more of a plurality of locations, the plurality of locations including a first location above the entryway, and a second location on the floor of the entryway. In addition or as an alternative the method may include one or more of the above disclosed aspects.

### BRIEF DESCRIPTION OF THE DRAWINGS

The following descriptions should not be considered limiting in any way. With reference to the accompanying drawings, like elements are numbered alike:

FIG. 1 is a schematic illustration of an elevator system that may employ various embodiments of the present disclosure;

FIG. 2 illustrates entryway indicators above elevator entryways;

FIG. 3 illustrates entryway indicators projected to on elevator landing; and

FIG. 4 illustrates technology features that may be utilized according to an embodiment.

### DETAILED DESCRIPTION

A detailed description of one or more embodiments of the disclosed apparatus and method are presented herein by way of exemplification and not limitation with reference to the Figures.

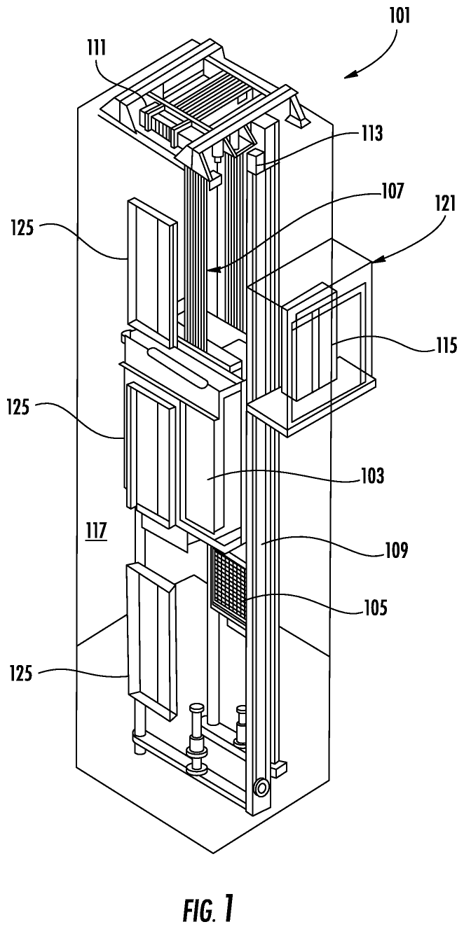

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

Other embodiments, the system comprises a conveyance system that moves passengers between floors and/or along a single floor. Such conveyance systems may include escalators, people movers, etc. Accordingly, embodiments described herein are not limited to elevator systems, such as that shown in FIG. 1.

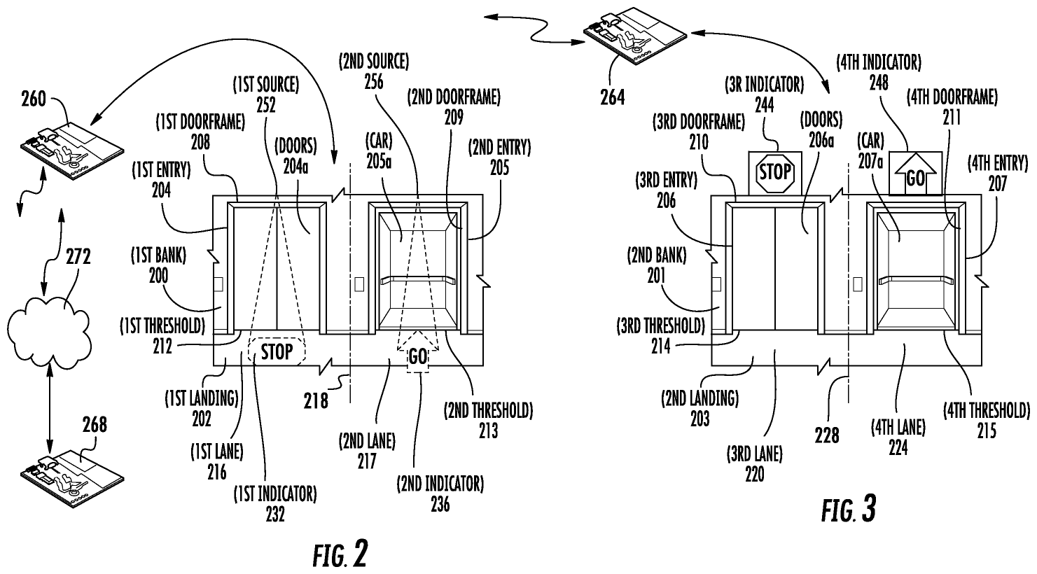

Turning to FIGS. 2 and 3, a plurality of elevator banks are illustrated including a first elevator bank 200 and a second elevator bank 201. The first plurality of elevator banks may include a plurality of elevator landings including a first landing 202 for the first elevator bank 200 and a second landing 203 for the second elevator bank 201.

The first elevator bank 200 may have a first plurality of entryways which may be elevator entryways providing egress to the elevators. The first plurality of entryways may include a first entryway 204 with a first pair of elevator doors 204a and a second entryway 205 with a first exposed elevator car 205a. The second elevator bank 201 may have a second plurality of entryways including a third entryway 206 with a second pair of elevator doors 206a and a fourth entryway 207 with a second exposed elevator car 207a. Each of the plurality of entryways may be designed for central loading and loading of occupants though such a design is not intended to be limiting.

The first plurality of entryways may be surrounded by a first plurality of doorways which may be architectural fenestrations. The first plurality of doorways may include a first doorway 208 for the first entryway 204 and a second doorway 209 for the second entryway 205. Similarly the second plurality of elevator entryways may be surrounded by a second plurality doorways. The second plurality of doorways may include a third doorway 210 for the third entryway 206 and a fourth doorway 211 for the fourth entryway 207.

The first plurality of entryways may include a first plurality of elevator thresholds, including a first threshold 212 for the first entryway 203 and a second threshold 213 for the second entryway 204. The second plurality of entryways may include a second plurality of elevator thresholds including a third threshold 214 for the third entryway 206 and a fourth threshold 215 for the fourth entryway 207.

To function as a people flow management system, the first elevator bank 200 may include a first plurality of traffic entry lanes on the first landing 202 including a first entry lane 216 for the first entryway 204 and a second entry lane 217 for the second entryway 205. The first plurality of traffic entry lanes may be separated graphically herein by a first lane divider 218. The second elevator bank 201 may include a second plurality of traffic entry lanes on the second landing 203 including a third lane 220 for the third entryway 206 and a fourth lane 224 for the fourth entryway 207. The second plurality of traffic entry lanes may be separated graphically herein by a second lane divider 228.

The first plurality of traffic entry lanes may include a first plurality of lane control indicators including a first traffic control indicator 232 for the first traffic lane 216 and a second traffic control indicator 236 for the second traffic lane entryway 205. The second plurality of traffic entry lanes may include a second plurality of traffic control indicators including a third traffic control indicator 244 for the third traffic lane 220 and a fourth traffic control indicator 248 for the fourth traffic lane 224.

The first plurality of lane control indicators are a first plurality of traffic control symbols electronically generated and projected onto the first landing 202. The first indictor 232 may be a first symbol, which may be a red octagon with textual indicia “stop”, indicating the first lane 216 is in a closed state, that is, inaccessible to people, and passengers cannot board the elevator because the elevator doors 204a are blocking access. The second indictor 236 may be a second symbol, which may be a green arrow with textual indicia “go”, indicating the second lane 217 is in an open state, that is, accessible for people flow, and passengers can board the elevator car 205a.

The second plurality of lane control indicators are a second plurality of traffic control symbols electronically generated and projected above the second landing 203. The third indictor 244 may be a third symbol, which may be a red octagon with textual indicia “stop”, indicating the third lane 220 is in a closed state.

The fourth indictor 248 may be a fourth symbol, which may be a green arrow with indicia “go”, indicating the fourth lane 224 is in an open state. The third and fourth symbols may be the same as or differ graphically from the first and second symbols respectively.

It is to be appreciated that the traffic control symbols identified herein may be compliant with the ‘1968 Vienna Convention on Road Signs and Signals,’ for example as published at http://www.trafficsign.us/oldmuted/1978/2b-regulatorysigns.pdf, incorporated herein by reference, but which is not intended to be limiting. It is to be further appreciated that the traffic control symbols illustrated may be for a specific usage circumstance with the plurality of entryways in the plurality of elevator banks.

Numerous permutations of the above symbols will occur for a corresponding numerous usage circumstances. For example, when an accessible elevator is adjacent to an inaccessible elevator, the system may display one color for the accessible elevator, such as green, and another color for the inaccessible color, such as red. Alternatively, the system may display one set of text for the accessible elevator, such as “go”, and another set of text for the inaccessible elevator, such a “stop”. Yet alternatively, the system may display a single text character for the accessible elevator, such as a check mark, and another single text character for the inaccessible elevator, such as an “x” or an asterisk. Yet alternatively, the system may display one traffic symbol for the accessible elevator, such as an arrow, and another traffic symbol for the inaccessible elevator, such as an octagon. Moreover the system may use one or more types of identifiers for the accessible elevator, such as one or more of a color, a set of text, a single text character, and a traffic symbol, and use the same combination or a different combination of the one or more types of identifiers for the inaccessible elevator.

The first plurality of traffic control symbols may be generated by a first plurality of luminous sources disposed above the first elevator bank 200. The first plurality of traffic control symbols may include a first luminous source 252 disposed above the first entryway 204 and a second luminous source 256 disposed above the second entryway 205. The second plurality of traffic control symbols may be generated by a second plurality of luminous sources (not illustrated) disposed above the second elevator bank 201. The second plurality of traffic control symbols may include a third luminous source behind the third lane control indicator 244 and a fourth luminous source behind the fourth lane control indicator 248.

Alternative forms and locations for the illumination sources are within the scope of the disclosure. For example projectors, active displays such as televisions and monitors controlled by a local or remote network server are within the scope of the disclosure. Other features within the scope of the disclosure include floor mounted illuminous sources, ceiling mounted illuminous sources and illuminous sources that are behind the graphical indicia such as above or alongside the doorway. Active displays may use any one or more of technologies related to liquid crystal displays, light emitting diodes, cathode ray tubes, plasma arrays, and the like. Projector technologies may include screens that automatically retract or are stationary at the location where the indicia is displayed. In addition, each of the illuminous sources may be retractable on pivots, pulleys, conveyer systems or the like to be completely hidden from view when not in use. Moreover while one of the elevator banks may use one or more of the illuminous technologies disclosed here, another of the elevator banks may use one or more of the same or different illuminous technologies.

A plurality of controllers may be provided including a first controller 260 for controlling the first plurality of luminous sources and a second controller 264 for controlling the second plurality of luminous sources. The plurality of controllers may communicate with a system controller 268 over a network 272 to receive instructions on a type and timing of symbols to be illustrated with the plurality of lane control indicators. Further details about the plurality of controllers and communications over the network are provided below.

The disclosed embodiments generally provide visual cues that may be located on the landing in front of an elevator entryway, above the door frame, or projected onto the landing from over the door. As illustrated an example indicator may be an arrow to influence passengers to travel along a desired lane or path, such as the middle of the threshold for center opening doors as those illustrated in the figures. Both floor projections and over the door lighting may change colors to indicate imminent door closing (e.g. that the elevator is imminently inaccessible), or may provide an image of a green arrow on the floor or landing that may change to a stop sign when door closing is imminent. For example, an indicator of an accessible elevator (for example, a “go” text display) may be provided at approximately a same time, that is, concurrently, with an elevator door opening cycle. The indicator may change to a further indicator of the doors imminently closing a few seconds before the elevator doors begin to close. For example a color indicator of yellow may flash, or text indicating “imminent closure” may flash. Immediately before the doors close, for example within one second of the beginning of closing operation, the indicator may change to illustrate that the elevator is inaccessible (for example, a “stop” text display). This operation may help guide passengers into the elevator and prevent harm to passengers who might otherwise try to enter an elevator as the doors are closing.

Adding indicators to elevator doors and entryways may increase passenger understanding of the door operation, and reduce passenger anxiety. Communication of door status with such indicators to passengers may make door operation clearer to passengers, reducing passenger impacts, elevator callbacks, and passenger injuries. Door communication statistics may create an opportunity to reduce electrical and mechanical reopening cycles experienced by entryway systems, reducing component fatigue and reducing component replacement and enhancing passenger safety and efficiency.

The above disclosed usages are not limited to elevators but can extend to trains, aircraft boarding gates, and the like. In addition, during periods in which a lane is inaccessible to passengers, public service announcements, marketing materials and the like may be intermittently displayed with or in place of a “stop” symbol.

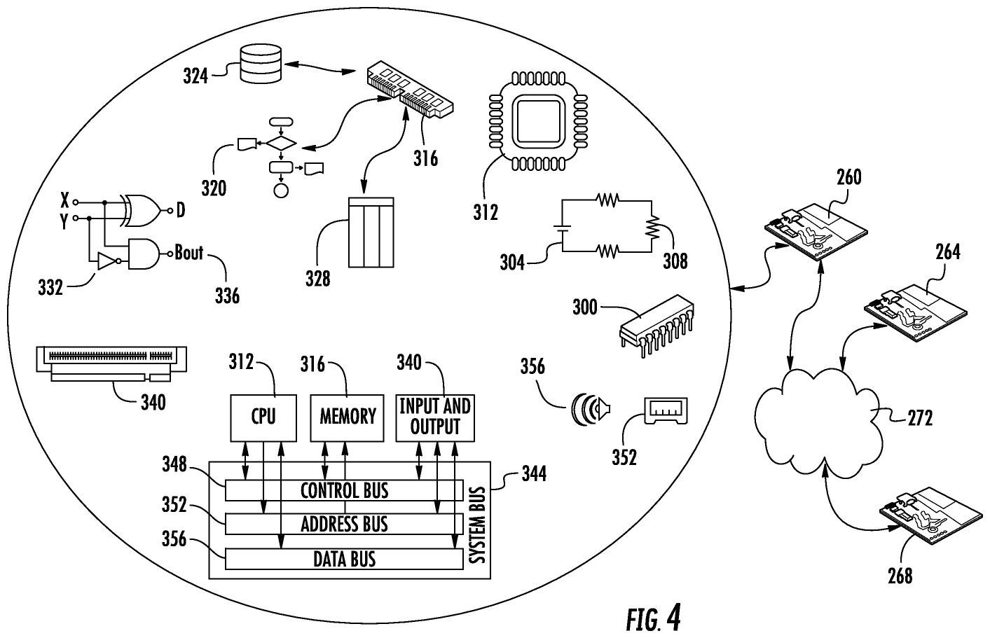

Turning now to FIG. 4, and as indicated above, the embodiments herein may include the plurality of controllers including the first controller 260, the second controller 264 and the third controller 268, which communicate over the network 272. In one embodiment, the first controller 260 and second controller 264 may be the same device, that is, one controller that controls both elevator banks such that no network therebetween is required. In one embodiment a single on-site controller is provided instead of the distributed system of controllers 260, 264 and 268. In one embodiment the elevator banks are controlled entirely by servers located over the World Wide Web, using a cloud computing configuration. In one embodiment, the distributed controller network is hard-wired for all telecommunication services so that no wireless network is necessary. In one embodiment redundant wireless and wired networks are utilized which automatically switch between such services to minimize network congestion.

Turning back to the figures, the plurality of illustrated controllers may have substantially the same technology features. Accordingly, features of the plurality of controllers may be disclosed hereinafter with reference to the first controller 260, which may be generally referred to hereinafter as controller 260.

The controller 260 may be a computing device that includes processing circuitry that may further include an application specific integrated circuit (ASIC) 300, an electronic circuit 304 with one or more elemental circuit components such as resistors 308, an electronic processor (shared, dedicated, or group) 312 and memory 316 that executes one or more software or firmware algorithms and programs 320, contains relevant data 324 which may be dynamically collected or disposed in one or more look-up tables 328, a combinational logic circuit 332 that contains one or more operational amplifiers 336, and/or other suitable interfaces and components that provide the described functionality. For example, the processor 312 processes data 324 stored in the memory 316 and employs the data 324 in various control algorithms 320, diagnostics and the like.

The controller 260 may further include, in addition to a processor 312 and memory 316, one or more input and/or output (I/O) device interface(s) 340 that are communicatively coupled via a local interface to communicate among the plurality of controllers. The local interface may include, for example but not limited to, an onboard system bus 344, including a control bus 348 (for inter-device communications), an address bus 352 (for physical addressing) and a data bus 356 (for transferring data). That is, the system bus 1344 enables the electronic communications between the processor 312, memory 312 and I/O connections 340. The local interface may also include wired connections 352 and/or wireless connections 356. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

In operation, the processor 312 onboard the controller 260 may be configured to execute the algorithms 320 stored within the memory 316, to communicate data 324 to and from the memory 316, and to generally control computing operations pursuant to the software 320. The algorithms 320 in the memory 316, in whole or in part, may be read by the processor 312, perhaps buffered within the processor 312, and then executed. The processor 312 may include hardware devices for executing the algorithms 320, particularly algorithms 320 stored in memory 316. The processor 312 may be a custom made or a commercially available processor 312, a central processing units (CPU), an auxiliary processor among several processors associated with computing devices, semiconductor based microprocessors (in the form of microchips or chip sets), or generally any such devices for executing software.

The memory 316 onboard the controller 260 may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 316 may incorporate electronic, magnetic, optical, and/or other types of storage media. The memory 316 may also have a distributed architecture, where various components are situated remotely from one another, but may be accessed by the processor 312.

The algorithms 320 in the memory 316 onboard the controller 260 may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the algorithms 320 may be translated via a compiler, assembler, interpreter, or the like, which may or may not be included within the memory.

Some of the input/output (I/O) devices that may be coupled to the controller 260 using the system I/O Interface(s) 340, the wired interfaces 352 and/or the wireless interfaces 356 will now be identified but the illustration of which shall be omitted for brevity. Such I/O devices include, but are not limited to (i) input devices such as a keyboard, mouse, scanner, microphone, camera, proximity device, etc., (ii) output devices such as a printer, display, etc., and (iii) devices that communicate both as inputs and outputs, such as a modulator/demodulator (modem; for accessing another device, system, or network), a radio frequency (RF) or other transceiver, a telephonic interface, a bridge, a router, etc.

Further, using the wireless connection 356, the controller 260 may communicate over the network 272 by applying electronic short range communication (SRC) protocols. Such protocols may include local area network (LAN) protocols and/or a private area network (PAN) protocols. LAN protocols include WiFi technology, which is a technology based on the Section 802.11 standards from the Institute of Electrical and Electronics Engineers, or IEEE. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the Institute of Electrical and Electronics Engineers (IEEE). More specifically, Zigbee represents a suite of high-level communication protocols used to create personal area networks with small, low-power digital radios for low-power low-bandwidth needs, and is best suited for small scale projects using wireless connections. Such wireless connection 356 may include Radio-frequency identification (RFID) technology, which is another SRC technology used for communicating with an integrated chip (IC) on an RFID smartcard.

One should note that the above disclosed architecture, functionality, and/or hardware operations of the controller 260 may be implemented by the algorithms 320. In the algorithms 320, such functionality may be represented as a module, segment, or portion of code, which comprises one or more executable instructions for implementing the specified logical function(s). It should also be noted that such modules may not necessarily be executed in any particular order and/or executed at all.

One should also note that any of the functionality of the controller 260 described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates and/or transports the program for use by or in connection with the instruction execution system, apparatus, or device. The computer readable medium may be, for example but not limited to, an electronic, magnetic, optical, electromagnetic, infrared, or semiconductor system, apparatus, device or form of computer readable memory 316. More specific examples (a non-exhaustive list) of a computer-readable medium the illustration of which being omitted for brevity include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A people flow management system comprising:
an entryway through which people pass through,
an image control apparatus that displays a first plurality of graphical indicia, the first plurality of graphical indicia being directed to controlling a flow of people passing through the entryway and comprising a first indicia indicative of the entryway being accessible for people passing through and a second indicia indicative of the entryway being inaccessible,
wherein the image control apparatus displays an indicia from the first plurality of graphical indicia at one or more of a plurality of locations, the plurality of locations including:
a first location above the entryway, and
a second location on a floor below the entryway.

2. The management system of claim 1 wherein
the first indicia graphically indicates the entryway is accessible for passing through, and
the second indicia graphically indicates the entryway is inaccessible, and
wherein the first plurality of graphical indicia includes a third indicia that graphically indicates the entryway is imminently inaccessible.

3. The management system of claim 2 wherein the first indicia graphically identifies that an accessible travel path for approaching the entryway is through a center of an entryway threshold.

4. The management system of claim 3 wherein
the first indicia includes a first shape, and
the second indicia includes a second shape, the second shape being different than the first shape.

5. The management system of claim 4 wherein
the first shape is a first color, and
the second shape is a second color, the second color being different than the first color.

6. The management system of claim 5 wherein
the first indicia includes first text overlying the first shape, and
the second indicia includes second text overlying the second shape, wherein the second text differs from the first text.

7. The management system of claim 6 wherein the image control feature comprises:
a luminous source for variously displaying the first plurality of graphical indicia,
a first controller for controlling when the illuminous source displays the first plurality of graphical indicia.

8. The management system of claim 7 wherein the luminous source is electronic display including an active panel display or a projecting display, wherein the electronic display is supported above the entryway or on the floor.

9. The management system of claim 8 wherein the first controller receives from a second controller a second plurality of graphical indicia directed to marketing for displaying with the illuminous source.

10. The management system of claim 9 wherein the first controller controls the illuminous source to contemporaneously display the plurality of graphical indicia.

11. A method of controlling a flow or people through an entryway,
the method including:
displaying a first plurality of graphical indicia, the first plurality of graphical indicia being directed to controlling a flow of people passing through the entryway and comprising a first indicia indicative of the entryway being accessible for people passing through and a second indicia indicative of the entryway being inaccessible,
wherein the first plurality of graphical indicia is displayed at one or more of a plurality of locations, the plurality of locations including
a first location above the entryway, and
a second location on the floor of the entryway.

12. The method of claim 11 wherein
the first indicia graphically indicates the entryway is accessible for passing through, and
the second indicia graphically indicates the entryway is inaccessible, and
wherein the first plurality of graphical indicia includes a third indicia that graphically indicates the entryway is imminently inaccessible.

13. The method of claim 12 wherein the first indicia graphically identifies that an accessible travel path for approaching the entryway is through a center of an entryway threshold.

14. The method of claim 13 wherein
the first indicia includes a first shape, and
the second indicia includes a second shape, the second shape being different than the first shape.

15. The method of claim 14 wherein
the first shape is a first color, and
the second shape is a second color, the second color being different than the first color

16. The method of claim 15 wherein
the first indicia includes first text overlying the first shape, and
the second indicia includes second text overlying the second shape, wherein the second text differs from the first text.

17. The method of claim 16 wherein the image control feature comprises:
a luminous source for variously displaying the first plurality of graphical indicia,
a first controller for controlling when the illuminous source displays the first plurality of graphical indicia.

18. The method of claim 17 wherein the luminous source is electronic display including an active panel display or a projecting display, wherein the electronic display is supported above the entryway or on the floor.

19. The method of claim 18 wherein the first controller receives from a second controller a second plurality of graphical indicia directed to marketing for displaying with the illuminous source.

20. The method of claim 19 wherein the first controller controls the illuminous source to contemporaneously display the plurality of graphical indicia.
